(19) United States
(12) Patent Application Publication
(10) Pub. No.: US 2003/0116993 A1
(43) Pub. Date: Jun. 26, 2003

(54) Vehicle part and method of making same

(76) Inventors: Brian P. Skarb, Warren, MI (US); Terrence D. Gibney Jr, Livonia, MI (US); Richard D. George, Rochester Hills, MI (US); Michael J. Berta, Rochester Hills, MI (US)

Correspondence Address: BROOKS & KUSHMAN P.C. / LEAR CORPORATION, 1000 TOWN CENTER TWENTY-SECOND FLOOR, SOUTHFIELD, MI, 48075, US

(21) Appl. No.: 10/239,834

(22) PCT Filed: Oct. 31, 2001
(86) PCT No.: PCT/US01/45632

(51) Int. Cl. B60J 5/00

(52) U.S. Cl. 296/146.7

(57) ABSTRACT

A part for use with a vehicle includes a structural member made of foamed plastic material. The part also includes an expanded polypropylene substrate integrally attached to the structural member. Furthermore, the substrate cooperates with the structural member to provide a sufficient structural characteristic to the part.

### BACKGROUND OF THE INVENTION

1. Field of the Invention

The invention relates to vehicle interior parts and a method of making such parts.

2. Background Art

Various interior parts, such as door assemblies, have been developed for use with motor vehicles. Such door assemblies are configured to be mounted onto a vehicle door outer structure. Examples of prior door assemblies are disclosed in U.S. Pat. Nos. 4,648,208; 4,882,842 and 5,095,659.

Another prior door assembly includes a carrier panel made of foamed polypropylene and a trim panel made of injection molded polypropylene. The carrier panel is attachable to a door outer structure of a vehicle, and the trim panel is attachable to the carrier panel with fasteners, after the carrier panel has been attached to the door outer structure. Furthermore, the trim panel defines the entire appearance surface of the door assembly.

### SUMMARY OF THE INVENTION

Under the invention, a part for use with a vehicle includes a structural member made of foamed plastic material. The part also includes an expanded polypropylene substrate attached to the structural member. Furthermore, the substrate cooperates with the structural member to provide a sufficient structural characteristic to the part.

### BRIEF DESCRIPTION OF THE DRAWINGS

FIG. 1 is a perspective view of a door assembly according to the invention mounted to a door outer structure;

FIG. 2 is an exploded perspective view of the door assembly showing lower and upper modules of the door assembly;

FIG. 3 is a cross-sectional view of the lower and upper modules, wherein each module includes a carrier frame and a substrate molded to the carrier frame;

FIG. 4 is side view of each carrier frame showing an outer surface of each carrier frame; and

FIG. 5 is a cross-sectional view of a mold for use in manufacturing the lower module.

### DETAILED DESCRIPTION OF THE PREFERRED EMBODIMENT(S)

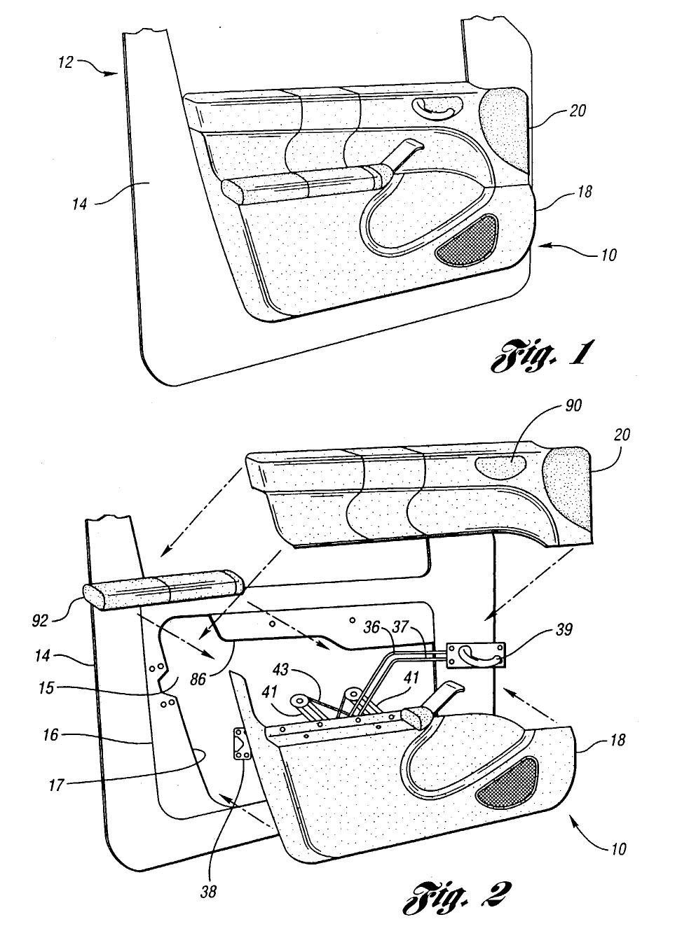

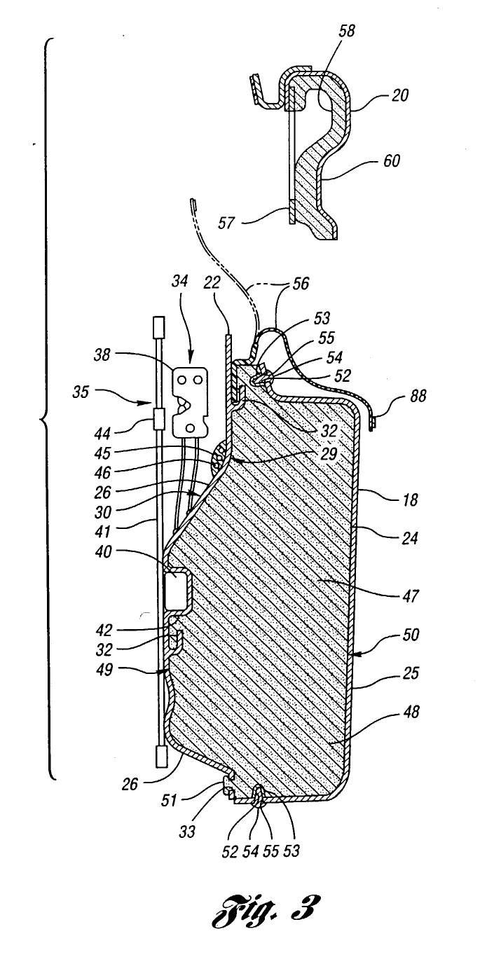

FIGS. 1 and 2 show a vehicle interior part, such as a door assembly 10, for use with a vehicle 12 having a door outer structure 14 and an interior occupant compartment. The door outer structure 14 may be a metallic structure and includes an outer panel 15 and an inner panel 16 attached to the outer panel 15. The inner panel 16 has an aperture 17 for receiving the door assembly 10.

The door assembly 10 includes first and second portions or modules, such as lower and upper portions or modules 18 and 20, respectively, that are attachable to the door outer structure 14. Alternatively, the first and second modules may have any suitable configuration. For example, the first and second modules may be outer and central modules, respectively, such as disclosed in co-pending application Serial No. ______ (Attorney Docket No. LEAR 0936 PUS).

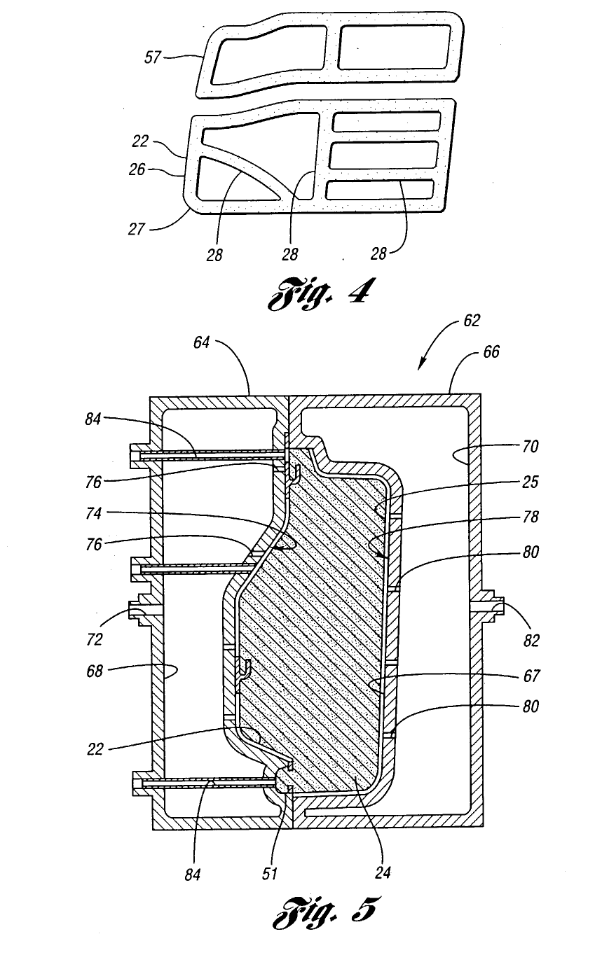

Referring to FIGS. 2 and 3, the lower module 18 includes a first structural member, such as first carrier frame 22, a first substrate 24 attached to the first carrier frame 22, and a first cover material 25 attached to the first substrate 24. The first carrier frame 22 is made of foamed plastic material, such as foamed polypropylene, and includes a first main body 26 that is sufficiently rigid so as to provide sufficient structural support to the first substrate 24 such that the lower module 18 is self-supporting. Referring to FIGS. 3 and 4, for example, the first main body 26 may be configured as an open framework having an outer frame 27 and one or more horizontal, vertical and/or diagonal support members 28. The first main body 26 also has a first or inner surface 29 that faces the substrate 24 and/or occupant compartment, and a second or outer surface 30 that faces the outer panel 15 of the door outer structure 14. The first carrier frame 22 may also include one or more attachment features, such as hook-shaped, integral projections 32 that extend from the first main body 26, and/or apertures 33 formed in the first main body 26. The projections 32 and/or apertures 33 may be used to facilitate attachment with the first substrate 24, as explained below in detail.

The first carrier frame 22 may also be configured to support one or more vehicle door hardware components. In the embodiment shown in FIGS. 2 and 3, for example, the door module 10 includes a door latch assembly 34 and a window regulator or lift mechanism 35 mounted to the first carrier frame 22. The door latch assembly 34 is mounted on outer surface 30 of the first carrier frame 22 in any suitable manner, and includes actuating links 36 and 37 extending between and connected to door latch 38 and handle mechanism 39.

The window lift mechanism 35 includes a motor 40 mounted on the inner surface 29 or the outer surface 30 of the first carrier frame 22, and a pair of window regulator arms 41 pivotally mounted on the outer surface 30 for supporting an associated door window (not shown) for vertical movement. The motor 40 and regulator arms 41 may be mounted to the first carrier frame 22 with any suitable fasteners. The first carrier frame 22 may also include a motor housing 42 that is integrally formed with the first main body 26, and that is configured to house the motor 40. Alternatively, the motor 40 may be attached to one of the regulator arms 41. The window lift mechanism 35 also includes a cable 43 that extends along each regulator arm 41 between ends thereof, and between the regulator arms 41 in a crossing manner. The cable 43 has a pair of window connectors 44 respectively associated with the regulator arms 41 to provide connection to the door window (not shown). Each window connector 44 is movable along a respective regulator arm 41 to enable vertical movement of the door window.

Alternatively, the window lift mechanism 35 may have any suitable configuration and include any suitable components. For example, the window lift mechanism 35 may include only one regulator arm and two glass guides mounted to the first carrier frame 22 on opposite sides of the regulator arm.

Additional components, such as a wire harness 45 and speaker (not shown), may also be mounted on the first carrier frame 22. The wire harness 45 includes various wires 46 and associated electrical connectors (not shown) for operating electrical components of the door assembly 10, such as window lift mechanism 35, a power door lock mechanism, a vehicle seat control, etc. Additional details regarding components that may be attached to lower module 18 are disclosed in co-pending application Ser. No. 09/690,635, which is hereby incorporated by reference.

Alternatively, the first structural member may have any suitable configuration that is sufficiently rigid to provide sufficient structural support to the first substrate 24 such that the lower module 18 is self-supporting. For example, the first structural member may be a solid panel. In addition, such a panel may be provided with one or more attachment features, such as the attachment features described above in detail.

The first substrate 24 includes a first substrate body 47 that is formed from expanded polypropylene (EPP) foam, and the first substrate body 47 cooperates with the first carrier frame 22 to provide a sufficient structural characteristic to the lower module 18. For example, as mentioned above, the structural characteristic may enable the lower module 18 to be self-supporting. In addition, the structural characteristic may enable the lower module 18 to support additional components that are provided as part of the lower module 18.

The first substrate body 47 may further be configured to exhibit significant sound absorption and/or energy management characteristics. For example, the first substrate body 47 may include integrated energy management members or pads 48. Because the expanded polypropylene foam may also be substantially moisture non-permeable, the first substrate body 47 may also function as a water barrier or shield that inhibits water from passing from outer surface 49 of the first substrate body 47 to inner surface 50.

The first substrate body 47 may be attached to the first carrier frame 22 in any suitable manner, such as with a mechanical bond and/or a fusion bond. In the embodiment shown in FIG. 3, for example, the first substrate body 47 is formed around the projections 32 of the first carrier frame 22 so as to form a mechanical bond between the first substrate 24 and the first carrier frame 22. Alternatively or supplementally, the first substrate 24 may be formed with one or more attachment features, such as integral projections 51, that extend from the first substrate body 47 and through the apertures 33 so as to mechanically bond the first substrate 24 to the first carrier frame 22. As yet another alternative, the first substrate 24 may partially or completely surround the first carrier frame 22 so as to mechanically bond the first substrate 24 to the first carrier frame 22. As yet another alternative or in addition to the above attachment means, the first substrate 24 and the first carrier frame 22 may be fused together.

The first substrate 24 may also include one or more attachment elements, such as receptacles 52, that may be used to attach the first cover material 25 to the first substrate 24. The receptacles 52 may be defined, for example, by conical inserts 53 that are attached to the first substrate body 47, as explained below in greater detail. The inserts 53 may be formed of any suitable material, such as polypropylene or other plastic material. Alternatively, the receptacles 52 may be integrally formed as part of the first substrate body 47.

The first cover material 25 is arranged to face the occupant compartment of the vehicle 12. Furthermore, the first cover material 25 may comprise any suitable cover material, such as a thermal polyolefin (TPO) skin, carpet, cloth, vinyl, leather, etc. If it is desirable that the lower module 18 be recyclable as a unit, the first cover material 25 may comprise polypropylene. In the embodiment shown in FIG. 3, for example, the first cover material 25 includes a TPO skin attached to a polypropylene foam backing layer. Furthermore, the backing layer may be reinforced with fibers such as flax.

While the first cover material 25 may be attached to the first substrate 24 in any suitable manner, such as with a fusion bond and/or adhesive, in the embodiment shown in FIG. 3, the first cover material 25 is attached to the first substrate 24 with removable fasteners, such as conical pins 54. The pins 54 extend through holes 55 in the first cover material 25 and removably engage the receptacles 52 of the first substrate 24. The pins 54 may be, for example, “Christmas Tree” fasteners that include laterally extending ridges (not shown) for engaging the receptacles 52. With such a configuration, the first cover material 25 may be removed and replaced if, for example, the first cover material 25 is damaged during shipping or handling.

Alternatively, the first cover material 25 may be eliminated if not needed for a particular application. In such a case, the first substrate 24 may be formed with an appearance surface that is arranged to face the occupant compartment of the vehicle 12.

The lower module 18 may further include a water barrier or shield 56 attached to the first carrier frame 22 and/or first substrate 24, and attachable to the inner panel 16 of the door outer structure 14. The water shield 56 is configured to inhibit water from passing from the door outer structure 14 to inner surface 50 of the first substrate 24. While the water shield 56 may comprise any suitable material, in the embodiment shown in FIG. 3, the water shield comprises a flexible material such as polyethylene.

Referring to FIGS. 2-4, the upper module 20 is attachable to the lower module 18 and/or the inner panel 16, and cooperates with the lower module 18 to substantially cover the aperture 17 in the door outer structure 14. The upper module 20 may be attached to the lower module 18 and/or inner panel 16 with any suitable fasteners and/or by an interference fit, such as a snap fit. The upper module 20 may include, for example, a second structural member, such as second carrier panel or frame 57, a second substrate 58 attached to the second carrier frame 57, and a second cover material 60 attached to the second substrate 58. The second carrier frame 57, second substrate 58 and second cover material 60 may respectively comprise the same materials as the first carrier frame 22, first substrate 24 and first cover material 25. Alternatively, the upper module 20 may have any suitable configuration and comprises any suitable materials. For example, the second frame 57 may be omitted if not required for a particular application. As another example, the upper module 20 may only include the second substrate 58, which may be formed so as to have a suitable appearance surface that faces the occupant compartment.

Referring to FIGS. 2-5, a method according to the invention of manufacturing a vehicle interior part, such as door assembly 10, will now be described in detail. The method includes forming the first carrier frame 22 of foamed plastic material, such as foamed polypropylene, foamed polyethylene and foamed urethane. Such a process may include, for example, injecting polypropylene or other plastic material into a first mold, and then injecting a gas, such as nitrogen, into the plastic material so as to create a foam interior portion surrounded by a resin rich surface. The resin rich surface forms a solid plastic shell or layer around the foam interior portion. More specifically, the outer frame 27 and the support members 28 may each be formed with a foam interior portion surrounded by a solid plastic layer. With such a configuration, the first carrier frame 22 is strong yet light weight.

The method further includes positioning the first carrier frame 22 in a second mold 62, shown in FIG. 5. The second mold 62 includes first and second mold portions 64 and 66, respectively, that cooperate to define a mold cavity 67 for forming the lower module 18. The first and second mold portions 64 and 66, respectively, are generally hollow so as to define first and second chambers 68 and 70, respectively. The first mold portion 64 has one or more inlets 72 for allowing a fluid, such as steam, to be introduced into the first chamber 68. The first mold portion 64 further includes a first mold surface 74 having one or more first apertures 76 formed therein for allowing steam to pass from the first chamber 68 into the mold cavity 67.

The second mold portion 66 includes a second mold surface 78 having one or more second apertures 80 formed therein for allowing steam and air to exit the mold cavity 67. In addition, the second mold portion 66 includes an outlet 82 connected to a vacuum source (not shown) that is operative to draw steam and air from the second chamber 70.

One or both of the mold portions 64 and 66 may also include one or more fill inlets 84 in communication with the mold cavity 67 for receiving EPP beads from a source (not shown) of EPP beads. In the embodiment shown in FIG. 5, the first mold portion 64 includes three fill inlets 84.

If the first cover material 25 is to be permanently attached to the first substrate 24, the method may also include positioning the first cover material 25 between the mold portions 64 and 66. Next, the method includes moving at least one of the mold portions 64 or 66 toward the other mold portion 64 or 66 so as to close the second mold 62. EPP beads are then introduced through the fill inlets 84 and into the mold cavity 67 such that some or all of the EPP beads are disposed between the first carrier frame 22 and the first cover material 25.

Next, the method includes causing the EPP beads to adhere to each other in the mold cavity 67 so as to form the first substrate 24 and to attach the first substrate 24 to the first carrier frame 22 and first cover material 25. This step may be accomplished, for example, by introducing steam through the inlets 72 and into the mold cavity 67. The vacuum source (not shown) may be used to draw steam and air through the mold cavity 67, and also to assist in holding the first carrier frame 22 and/or first cover material 25 in proper position in the mold cavity 67.

Because the first substrate 24 is molded directly to the first carrier frame 22, the first substrate 24 is integrally attached to the first carrier frame 22. As mentioned above, the means of attachment between the first carrier frame 22 and the first substrate 24 may include a fusion bond and/or a mechanical bond. For example, as the EPP beads adhere to each other, the EPP beads may also fuse with the first carrier frame 22. Alternatively or supplementally, the EPP beads may cooperate to form attachment features, such as the projections 51. As yet another example, the first substrate 24 may be formed in such a manner that the first substrate 24 partially or completely surrounds the first carrier frame 22. Under this approach, EPP beads may be introduced on both sides of the first carrier frame 22. Thus, as used herein, “integrally attached” means fusion bonded and/or mechanically bonded together without the need for separate fasteners.

If the first cover material 25 is to be removably attached to the first substrate 24, then the first cover material 25 is not inserted into the second mold 62. Instead, the first substrate 24 may be formed with the receptacles 52, shown in FIG. 3. For example, the inserts 53 may be positioned in the mold cavity 67 prior to the introduction of EPP beads, so as to define the receptacles 52. After the first substrate body 44 has been formed around the inserts 53, in a manner similar to that described above, the first cover material 25 may be attached to the first substrate 24 with the fasteners 54.

The method may further include attaching one or more vehicle door hardware components to the first carrier frame 22 such that the vehicle door hardware components are supported by the first carrier frame 22. For example, the method may include attaching the door latch assembly 34 and the window lift mechanism 35 to the first carrier frame 22 with any suitable fasteners (not shown).

The upper module 20 may be manufactured in a similar manner as described above with respect to the lower module 18. Furthermore, the second cover material 60 may be removably attached to the second substrate 58 in a similar manner as described above with respect to the lower module 18. Alternatively, the upper module 20 may be made in any suitable manner and comprise any suitable materials.

The above method may also be used to manufacture other vehicle interior parts, such as consoles, instrument panels, load floors and decorative trim panels. Each of these parts may be formed to include a structural member, such as a panel or frame, that comprises foamed plastic material. Each of these parts may also be formed to include a substrate attached to the structural member and comprising EPP foam. For each of these parts, the structural member provides structural support to the substrate, and the substrate cooperates with the structural member so as to provide a sufficient structural characteristic to the part. For example, the part may be self-supporting. Moreover, the part may configured to support additional components, which may be integrated into the part. Such components may, for instance, be mounted to the structural member.

Referring to FIGS. 2 and 3, a method of assembling the door assembly 10 to the door outer structure 14 will now be described. First, the lower module 18 is positioned adjacent the aperture 17 in the door outer structure 14. The regulator arms 41 are then pivoted into a substantially vertical position and are fastened to a flange 86 of inner panel 16. The door latch 38 is also fastened to the inner panel 16. Next, if the lower module 18 includes water shield 56, free end 88 of the water shield 56 may be moved to an assembled position (shown in phantom in FIG. 3) and attached to the inner panel 16 so as to cover the remainder of aperture 17. The upper module 20 is then positioned above the lower module 18, and the handle mechanism 39 is fed through opening 90 in the upper module 20. Next, the handle mechanism 39 is attached to the upper module 20, and the upper module 20 is attached to the lower module 18 and/or inner panel 16 in any suitable manner. Arm rest 92 may also be attached to lower module 18, if lower module 18 does not include an integral arm rest.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A part for use with a vehicle, the part comprising:
a structural member made of foamed plastic material; and
an expanded polypropylene substrate integrally attached to the structural member, wherein the substrate cooperates with the structural member to provide a sufficient structural characteristic to the part.

2. The part of claim 1 wherein the structural member includes a foam interior portion and a solid plastic exterior layer.

3. The part of claim 2 wherein the foamed plastic material is foamed polypropylene.

4. The part of claim 2 wherein the foamed plastic material is foamed polyethylene.

5. The part of claim 2 wherein the foamed plastic material is foamed urethane.

6. The part of claim 2 wherein the structural member is an open framework.

7. The part of claim 1 wherein the structural member includes a main body and a projection extending from the main body, and the substrate surrounds the projection so as to form a mechanical bond between the substrate and the structural member.

8. The part of claim 1 wherein the substrate substantially surrounds the structural member so as to form a mechanical bond between the substrate and the structural member.

9. The part of claim 1 wherein the structural member includes an aperture, and the substrate includes an integral projection that extends through the aperture so as to form a mechanical bond between the substrate and the structural member.

10. The part of claim 1 wherein the substrate is fused to the structural member.

11. The part of claim 1 further comprising a cover material covering at least a portion of the substrate and adapted to face an interior compartment of the vehicle when the part is attached to the vehicle.

12. The part of claim 11 further comprising at least one removable fastener for removably attaching the cover material to the substrate.

13. A door assembly for use with a vehicle door outer structure, the module comprising:
a first portion adapted to be attached to the outer structure and including a first structural member made of foamed plastic material, a first substrate integrally attached to the first structural member and formed from expanded polypropylene, and a first cover material covering at least a portion of the first substrate and configured to face a vehicle interior compartment when the first portion is attached to the outer structure.

14. The door assembly of claim 13 wherein the first structural member includes a foam interior portion and a solid plastic exterior layer.

15. The door assembly of claim 14 wherein the foamed plastic material is foamed polypropylene.

16. The door assembly of claim 14 wherein the foamed plastic material is foamed polyethylene.

17. The door assembly of claim 14 wherein the foamed plastic material is foamed urethane.

18. The door assembly of claim 14 wherein the first structural member is an open framework.

19. The assembly of claim 13 wherein the first structural member includes a main body and a projection extending from the main body, and the first substrate surrounds the projection so as to form a mechanical bond between the first substrate and the first structural member.

20. The assembly of claim 13 wherein the first substrate substantially surrounds the first structural member so as to form a mechanical bond between the first substrate and the first structural member.

21. The assembly of claim 13 wherein the first structural member includes an aperture, and the first substrate includes an integral projection that extends through the aperture so as to form a mechanical bond between the first substrate and the first structural member.

22. The assembly of claim 13 wherein the first substrate is fused to the first structural member.

23. The assembly of claim 13 further comprising at least one removable fastener for removably attaching the first cover material to the first substrate.

24. The assembly of claim 13 further comprising at least one vehicle door hardware component attached to and supported by the first structural member.

25. The assembly of claim 13 further comprising multiple vehicle door hardware components attached to and supported by the first structural member, the components including a window regulator mechanism and a door latch assembly.

26. The assembly of claim 13 wherein the first structural member includes a motor housing integrally formed therein, and wherein the assembly further includes a window regulator motor disposed in the housing and supported by the first structural member.

27. The assembly of claim 13 further including a second portion that is attachable to the outer structure at a position above the first portion, the second portion including a second structural member and a second substrate attached to the second structural member.

28. The assembly of claim 27 wherein the second structural member comprises foamed plastic material, and the second substrate comprises expanded polypropylene.

29. The assembly of claim 28 further comprising a water shield disposable between the first and second portions.

30. A method for making a part for use with a vehicle, the method comprising:
positioning a structural member in a mold, wherein the structural member comprises foamed plastic material;
introducing expanded polypropylene beads into the mold proximate the structural member; and
causing the expanded polypropylene beads to adhere to each other in the mold so as to form a substrate that is attached to the structural member, wherein the substrate cooperates with the structural member so as to provide a sufficient structural characteristic to the part.

31. The method of claim 30 wherein causing the expanded polypropylene beads to adhere to each other comprises introducing steam into the mold.

32. The method of claim 30 wherein the structural member includes a main body and a projection extending from the main body, and wherein introducing expanded polypropylene beads into the mold includes introducing expanded polypropylene beads around the projection, and causing the expanded polypropylene beads to adhere to each other includes causing the expanded polypropylene beads to adhere to each other so as to form the substrate such that the substrate surrounds the projection to thereby form a mechanical bond between the substrate and the structural member.

33. The method of claim 30 wherein introducing expanded polypropylene beads into the mold includes introducing expanded polypropylene beads such that the expanded polypropylene beads substantially surround the structural member, and causing the expanded polypropylene beads to adhere to each other includes causing the expanded polypropylene beads to adhere to each other so as to form the substrate such that the substrate substantially surrounds the structural member to thereby form a mechanical bond between the substrate and the structural member.

34. The method of claim 30 wherein the structural member includes an aperture, and wherein introducing expanded polypropylene beads into the mold includes introducing expanded polypropylene beads through the aperture, and causing the expanded polypropylene beads to adhere to each other includes causing the expanded polypropylene beads to adhere to each other so as to form the substrate such that the substrate extends through the aperture to thereby form a mechanical bond between the substrate and the structural member.

35. The method of claim 30 further comprising causing the expanded polypropylene beads to adhere to the structural member so as to fuse the substrate to the structural member.

36. The method of claim 30 further comprising attaching a cover material to the substrate so as to provide an appearance surface.

37. The method of claim 36 wherein attaching a cover material includes removably attaching the cover material to the substrate with at least one removable fastener.

38. The method of claim 30 further comprising positioning a cover material in the mold prior to introducing expanded polypropylene beads into the mold, and wherein introducing expanded polypropylene beads includes introducing expanded polypropylene beads between the structural member and the cover material.

39. A method for making a door module for use with a vehicle door outer structure, the method comprising:
positioning a structural member in a mold, wherein the structural member comprises foamed plastic material;
introducing expanded polypropylene beads into the mold proximate the structural member;
causing the expanded polypropylene beads to adhere to each other in the mold so as to form a substrate that is attached to the structural member, wherein the substrate cooperates with the structural member so as to provide a sufficient structural characteristic to the door module; and
attaching a cover material to the substrate so as to provide an appearance surface that is adapted to face a vehicle interior compartment when the door module is attached to the outer structure.

40. The method of claim 39 wherein causing the expanded polypropylene beads to adhere to each other comprises introducing steam into the mold.

41. The method of claim 39 wherein the structural member includes a main body and a projection extending from the main body, and wherein introducing expanded polypropylene beads into the mold includes introducing expanded polypropylene beads around the projection, and causing the expanded polypropylene beads to adhere to each other includes causing the expanded polypropylene beads to adhere to each other so as to form the substrate such that the substrate surrounds the projection to thereby form a mechanical bond between the substrate and the structural member.

42. The method of claim 39 wherein introducing expanded polypropylene beads into the mold includes introducing expanded polypropylene beads such that the expanded polypropylene beads substantially surround the structural member, and causing the expanded polypropylene beads to adhere to each other includes causing the expanded polypropylene beads to adhere to each other so as to form the substrate such that the substrate substantially surrounds the structural member to thereby form a mechanical bond between the substrate and the structural member.

43. The method of claim 39 wherein the structural member includes an aperture, and wherein introducing expanded polypropylene beads into the mold includes introducing expanded polypropylene beads through the aperture, and causing the expanded polypropylene beads to adhere to each other includes causing the expanded polypropylene beads to adhere to each other so as to form the substrate such that the substrate extends through the aperture to thereby form a mechanical bond between the substrate and the structural member.

44. The method of claim 39 further comprising causing the expanded polypropylene beads to adhere to the structural member so as to fuse the substrate to the structural member.

45. The method of claim 39 wherein attaching a cover material comprises positioning the cover material in the mold prior to introducing expanded polypropylene beads into the mold, and wherein introducing expanded polypropylene beads includes introducing expanded polypropylene beads between the structural member and the cover material.

46. The method of claim 39 wherein attaching a cover material includes removably attaching the cover material to the substrate with at least one removable fastener.

47. The method of claim 39 further comprising attaching at least one vehicle door hardware component to the structural member such that the at least one vehicle door hardware component is supported by the structural member.

48. The method of claim 39 further comprising attaching multiple vehicle door hardware components to the structural member such that the components are supported by the structural member, the components including a window regulator mechanism and a door latch assembly.

49. The method of claim 39 further comprising forming the structural member such that the structural member includes an integrally molded motor housing, and attaching a window regulator motor to the structural member such that the motor is disposed in the housing.

50. The method of claim 39 further comprising forming the structural member as an open framework.
